(19) United States
(12) Patent Application Publication
(10) Pub. No.: US 2019/0221129 A1
(43) Pub. Date: Jul. 18, 2019

(54) ASSESSMENT SYSTEM AND METHOD

(71) Applicant: ATeam Technologies Inc., San Francisco, CA (US)

(72) Inventor: ADAM G. COCKELL, San Francisco, CA (US)

(21) Appl. No.: 16/246,273

(22) Filed: Jan. 11, 2019

Related U.S. Application Data
(60) Provisional application No. 62/616,797, filed on Jan. 12, 2018.

(51) Int. Cl. G09B 5/00; G06K 9/00

(52) U.S. Cl. CPC G09B 5/00; G06K 9/00442

(57) ABSTRACT

A method, computer program product, and computing system for administering an electronic assessment to a first assessment participant and at least a second assessment participant; assigning a first grade to the first assessment participant based, at least in part, upon a first assessment response received from the first assessment participant concerning the electronic assessment; assigning at least a second grade to the at least a second assessment participant based, at least in part, upon at least a second assessment response received from the at least a second assessment participant concerning the electronic assessment; anonymizing at least a portion of the at least a second assessment response, thus generating at least a second anonymized assessment response; and providing the first grade and the at least a second anonymized assessment response to the first assessment participant.

### RELATED APPLICATION(S)

This application claims the benefit of the following: U.S. Provisional Application No. 62/616,797, filed on 12 Jan. 2018, the entire contents of which is herein incorporated by reference.

### TECHNICAL FIELD

This disclosure relates to electronic assessments and, more particularly, to systems that distribute responses to electronic assessments.

### BACKGROUND

Assessments may be utilized to gauge someone's competency in a specific area of expertise. For example, assessments may be utilized to determine how well a salesperson is at closing a deal; how well a customer service representative is at addressing an irate customer; and how well a medical professional is at tending to the sick.

As would be expected in in the age of computers, these assessments have migrated from being paper-based to being electronic. And there are many advantages of electronic assessments, such as easy distribution and administration, immediate grading and immediate reporting of results. Further, additional benefits may be realized when the abilities of such electronic assessments are fully exploited.

Summary of Disclosure

In one implementation, a computer-implemented method is executed on a computing device and includes: administering an electronic assessment to a first assessment participant and at least a second assessment participant; assigning a first grade to the first assessment participant based, at least in part, upon a first assessment response received from the first assessment participant concerning the electronic assessment; assigning at least a second grade to the at least a second assessment participant based, at least in part, upon at least a second assessment response received from the at least a second assessment participant concerning the electronic assessment; anonymizing at least a portion of the at least a second assessment response, thus generating at least a second anonymized assessment response; and providing the first grade and the at least a second anonymized assessment response to the first assessment participant.

One or more of the following features may be included. The at least a second anonymized assessment response may include at least a second grade associated with the at least a second response. The at least a second anonymized assessment response may include at least a second answer associated with the at least a second response. The at least a second anonymized assessment response may include at least a second explanation associated with the at least a second response. The at least a second assessment participant may include a plurality of assessment participants. The at least a second response may include a plurality of assessment responses. A document may be processed to generate the electronic assessment.

In another implementation, a computer program product resides on a computer readable medium and has a plurality of instructions stored on it. When executed by a processor, the instructions cause the processor to perform operations including administering an electronic assessment to a first assessment participant and at least a second assessment participant; assigning a first grade to the first assessment participant based, at least in part, upon a first assessment response received from the first assessment participant concerning the electronic assessment; assigning at least a second grade to the at least a second assessment participant based, at least in part, upon at least a second assessment response received from the at least a second assessment participant concerning the electronic assessment; anonymizing at least a portion of the at least a second assessment response, thus generating at least a second anonymized assessment response; and providing the first grade and the at least a second anonymized assessment response to the first assessment participant.

One or more of the following features may be included. The at least a second anonymized assessment response may include at least a second grade associated with the at least a second response. The at least a second anonymized assessment response may include at least a second answer associated with the at least a second response. The at least a second anonymized assessment response may include at least a second explanation associated with the at least a second response. The at least a second assessment participant may include a plurality of assessment participants. The at least a second response may include a plurality of assessment responses. A document may be processed to generate the electronic assessment.

In another implementation, a computing system includes a processor and memory is configured to perform operations including administering an electronic assessment to a first assessment participant and at least a second assessment participant; assigning a first grade to the first assessment participant based, at least in part, upon a first assessment response received from the first assessment participant concerning the electronic assessment; assigning at least a second grade to the at least a second assessment participant based, at least in part, upon at least a second assessment response received from the at least a second assessment participant concerning the electronic assessment; anonymizing at least a portion of the at least a second assessment response, thus generating at least a second anonymized assessment response; and providing the first grade and the at least a second anonymized assessment response to the first assessment participant.

One or more of the following features may be included. The at least a second anonymized assessment response may include at least a second grade associated with the at least a second response. The at least a second anonymized assessment response may include at least a second answer associated with the at least a second response. The at least a second anonymized assessment response may include at least a second explanation associated with the at least a second response. The at least a second assessment participant may include a plurality of assessment participants. The at least a second response may include a plurality of assessment responses. A document may be processed to generate the electronic assessment.

In another implementation, a computer-implemented method is executed on a computing device and includes: administering an electronic assessment to a first assessment participant and at least a second assessment participant; assigning a first grade to the first assessment participant based, at least in part, upon a first assessment response received from the first assessment participant concerning the electronic assessment; assigning at least a second grade to the at least a second assessment participant based, at least in part, upon at least a second assessment response received from the at least a second assessment participant concerning the electronic assessment; and providing the first grade and the at least a second assessment response to the first assessment participant.

One or more of the following features may be included. At least a portion of the at least a second assessment response may be anonymized prior to providing the at least a second assessment response to the first assessment participant. The at least a second assessment response may include at least a second grade associated with the at least a second assessment response. The at least a second assessment response may include at least a second answer associated with the at least a second assessment response. The at least a second assessment response may include at least a second explanation associated with the at least a second assessment response. The at least a second assessment participant may include a plurality of assessment participants. The at least a second assessment response may include a plurality of assessment responses. A document may be processed to generate the electronic assessment.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an assessment process according to an embodiment of the present disclosure;

FIG. 2 is a diagrammatic view of an electronic assessment generated by the assessment process of FIG. 1 according to an embodiment of the present disclosure; and

FIG. 3 is a flowchart of the assessment process of FIG. 1 according to an embodiment of the present disclosure.

Like reference symbols in the various drawings indicate like elements.

### DETAILED DESCRIPTION OF THE PREFERRED EMBODIMENTS

System Overview

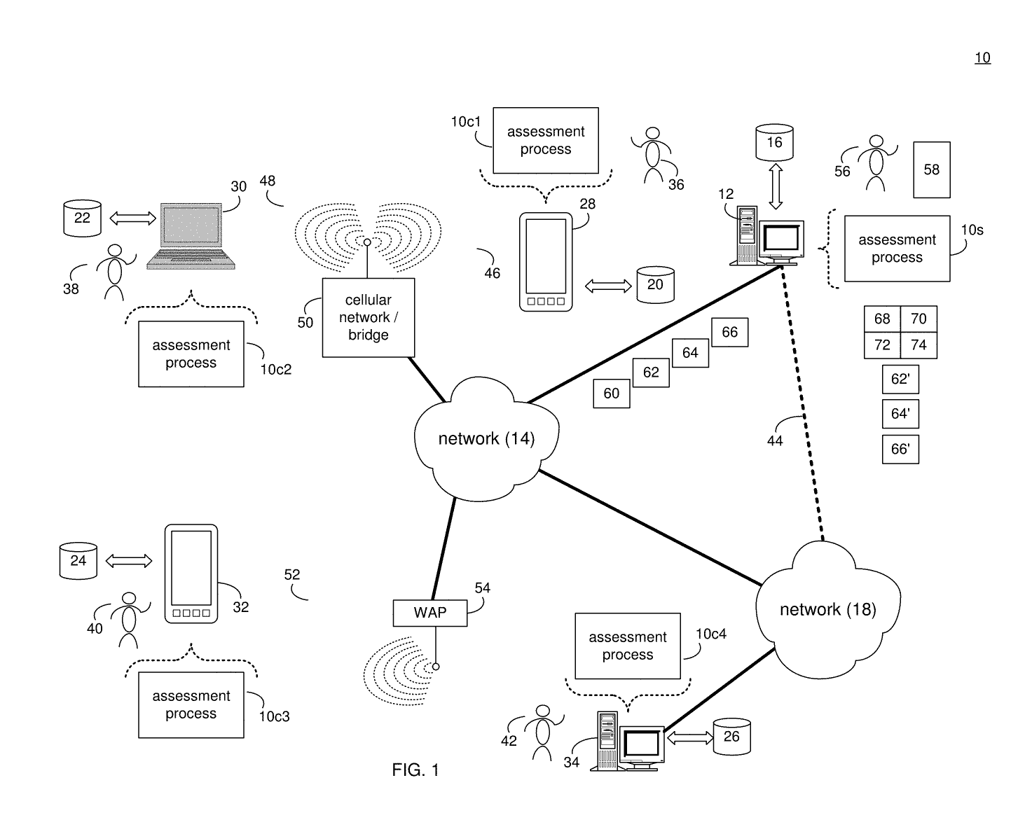

Referring to FIG. 1, there is shown assessment process 10. Assessment process 10 may be implemented as a server-side process, a client-side process, or a hybrid server-side/client-side process. For example, assessment process 10 may be implemented as a purely server-side process via assessment process 10s. Alternatively, assessment process 10 may be implemented as a purely client-side process via one or more of assessment process 10c1, assessment process 10c2, assessment process 10c3, and assessment process 10c4. Alternatively still, assessment process 10 may be implemented as a hybrid server-side/client-side process via assessment process 10s in combination with one or more of assessment process 10c1, assessment process 10c2, assessment process 10c3, and assessment process 10c4. Accordingly, assessment process 10 as used in this disclosure may include any combination of assessment process 10s, assessment process 10c1, assessment process 10c2, assessment process, and assessment process 10c4.

Assessment process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of assessment process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of assessment processes 10c1, 10c2, 10c3, 10c4 may include but are not limited to a client application, a web browser, a game console user interface, or a specialized application (e.g., an application running on e.g., the Android™ platform or the iOS™ platform). The instruction sets and subroutines of assessment processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access assessment process 10 directly through network 14 or through secondary network 18. Further, assessment process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Assessment Process

As will be discussed below in greater detail, assessment process 10 may be configured to administer electronic assessments to groups of participants and to provide feedback concerning the same. Assume that user 56 is the administrator of assessment process 10, wherein user 56 wishes to administer electronic assessment 58 to users 36, 38, 40, 42. Further, assume for this example that e.g. electronic assessment 58 is a document that is utilized to train sales associates (e.g., users 36, 38, 40, 42), wherein electronic assessment 58 may be configured to test the ability of users 36, 38, 40, 42 to spot and address issues with respect to the manner in which a sales process should be handled. For example, assume for illustrative purposes that electronic assessment 58 tells a fictional “story” about an interaction between a sales associate and a potential customer, wherein the participants (e.g., users 36, 38, 40, 42) of electronic assessment 58 are required to provide feedback concerning various portions of this fictional story.

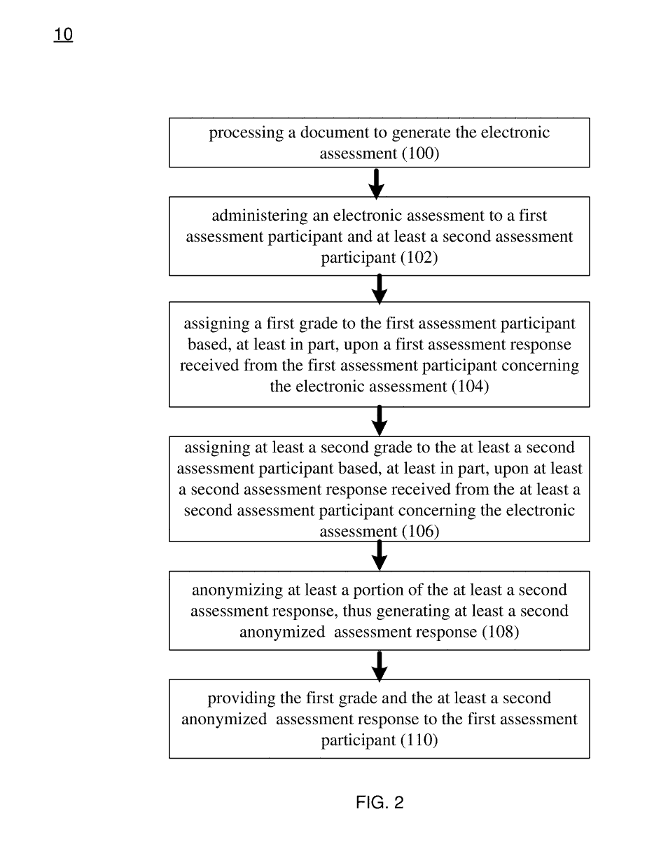

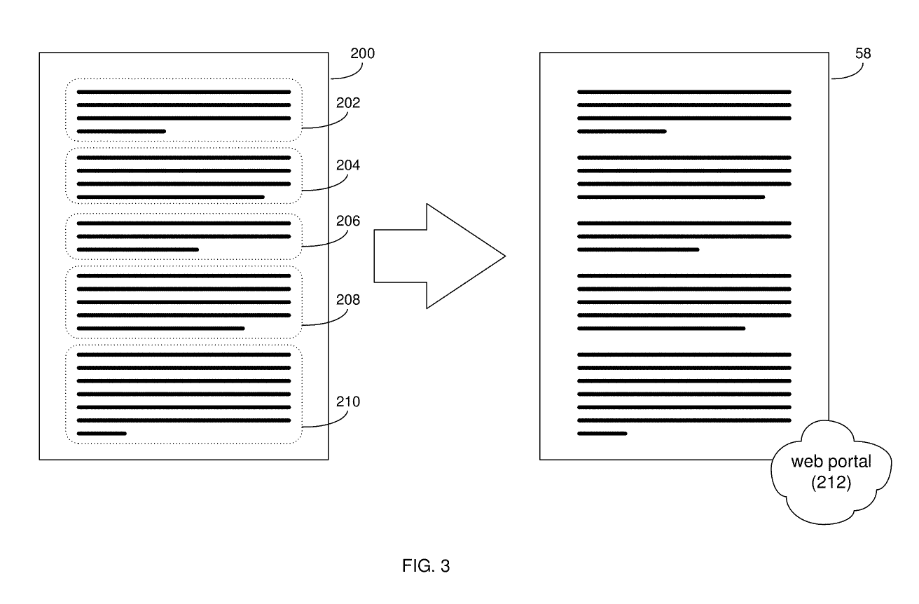

Referring also to FIGS. 2-3, assessment process 10 may be configured to process 100 a document (e.g. word processing document 200) to generate electronic assessment 58. For example, assume that word processing document 200 is initially a standard word processing document that was prepared by e.g. user 56 to tell the above-described fictional “story” concerning an interaction between a sales associate and the potential customer. And when processing 100 word processing document 200 to generate electronic assessment 58, assessment process 10 may allow user 56 to identify various portions (e.g. portions 202, 204, 206, 208, 210) of word processing document 200 for which the participants (e.g. users 36, 38, 40, 42) of electronic assessment 58 may be required to provide a response when taking electronic assessment 58. While in this example, electronic assessment 58 and the document being processed 100 are described as being a word processor document, this is for illustrative purposes only and is not intended to be a limitation of this disclosure, as other configurations are possible and are considered to be within the scope of this disclosure. For example, other types of documents may be utilized, examples of which may include but are not limited to slideshows, videos and multimedia presentations.

When processing 100 the document (e.g. word processing document 200) to generate electronic assessment 58, user 56 may be allowed to associate a response type with each of the portions (e.g. portions 202, 204, 206, 208, 210) of electronic assessment 58. For example, assessment process 10 may be configured to process 100 the document (e.g. word processing document 200) so that participants can provide responses in a binary fashion (e.g., correct/incorrect. true/false), provide responses by selecting from a plurality of answers (e.g., 1-3, 4-7, 8-12 & 13+), provide freeform responses (e.g., unconstrained responses in the words of the participant), and provide explanative responses (e.g., response that provide explanation/background concerning another response, such as why they chose “true”). Further, assessment process 10 may be configured to allow user 56 to set expectations for responses in order to validate that participant responses match. Further, assessment process 10 may be configured to use e.g., weighted user averages to determine which participants are right and which participants are wrong.

Once the processing 100 of the document (e.g. word processing document 200) to generate electronic assessment 58 is completed, assessment process 10 may administer 102 electronic assessment 58 to a first assessment participant and at least a second assessment participant. For example, assessment process 10 may administer 102 electronic assessment 58 to a plurality of participants (namely users 36, 38, 40, 42). For example, assessment process 10 may administer 102 electronic assessment 58 to users 36, 38, 40, 42 by e.g., emailing electronic assessment 58 to users 36, 38, 40, 42 or by allowing users 36, 38, 40, 42 to access electronic assessment 58 via a web portal (e.g. web portal 212).

Continuing with the above stated example, assume that users 36, 38, 40, 42 are notified (e.g., via email) that electronic assessment 58 is available via web portal 212. Accordingly, users 36, 38, 40, 42 may utilize web portal 212 to access electronic assessment 58. As discussed above in this example, electronic assessment 58 is shown to include five portions (e.g., portions 202, 204, 206, 208, 210) that each require the participant (e.g., users 36, 38, 40, 42) to provide a response. As discussed, these responses may be binary responses, multiple choice responses, freeform responses and/or explanative responses. Assume for illustrative purposes that each participant (e.g., each of users 36, 38, 40, 42) utilizes web portal 212 to complete electronic assessment 58 and provide a response (e.g., responses 60, 62, 64, 66 respectively) concerning the same. It is understood that the response provided by the participant (e.g., users 36, 38, 40, 42) may include a response to all or some of the above-described five portions (e.g., portions 202, 204, 206, 208, 210).

These responses (e.g., responses 60, 62, 64, 66) may be received (and processed) by assessment process 10 and assessment process 10 may assign a grade to each (e.g., a numeric grade or a letter grade). Specifically, assessment process 10 may assign 104 a first grade (e.g. first grade 68) to a first assessment participant (e.g., user 36) based, at least in part, upon a first assessment response (e.g. response 60) received from the first assessment participant (e.g., user 36) concerning electronic assessment 58. Additionally, assessment process 10 may assign 106 at least a second grade to at least a second assessment participant based, at least in part upon at least a second assessment response received from the at least a second assessment participant concerning electronic assessment 58. The at least a second assessment participant may include a plurality of assessment participants (e.g., users 38, 40, 42) and the at least a second response may include a plurality of assessment responses (e.g., responses 62, 64, 66).

Specifically, assessment process 10 may assign 106 a second grade (e.g., grade 70) to a second assessment participant (e.g., user 38) based, at least in part, upon a second assessment response (e.g., response 62) received from the second assessment participant (e.g., user 38) concerning electronic assessment 58. Further, assessment process 10 may assign 106 a third grade (e.g., grade 72) to a third assessment participant (e.g., user 40) based, at least in part, upon a third assessment response (e.g., response 64) received from the third assessment participant (e.g., user 40) concerning electronic assessment 58. Additionally, assessment process 10 may assign 106 a fourth grade (e.g., grade 74) to a fourth assessment participant (e.g., user 42) based, at least in part, upon a fourth assessment response (e.g., response 66) received from the fourth assessment participant (e.g., user 42) concerning electronic assessment 58.

In order to allow all participants of electronic assessment 58 to learn from the responses (e.g., responses 60, 62, 64, 66) provided to assessment process 10, these responses (e.g., responses 60, 62, 64, 66) may be shared with all participant (e.g. users 36, 38, 40, 42). Additionally and in order to avoid any potential embarrassment (concerning the responses submitted) and to encourage people to participate in electronic assessment 58, assessment process 10 may anonymize 108 at least a portion of the responses (e.g., responses 60, 62, 64, 66) before they are shared. For example, the responses provided to a first participant that were submitted by other participants may be anonymized 108 (in whole or in part) before they are shared with the first participant.

According and with respect to user 36, assessment process 10 may: anonymize 108 at least a portion of the second assessment response (e.g., response 62), thus generating a second anonymized assessment response (e.g., response 62′); anonymize 108 at least a portion of the third assessment response (e.g., response 64), thus generating a third anonymized assessment response (e.g., response 64′); and anonymize 108 at least a portion of the fourth assessment response (e.g., response 66), thus generating a fourth anonymized assessment response (e.g., response 66′).

Assessment process 10 may then provide 110 the first grade (e.g., first grade 68) and the at least a second anonymized assessment response to the first assessment participant (e.g., user 36). Specifically, assessment process 10 may provide 110 user 36 with first grade 68 (i.e., the grade that user 36 received for response 60), second anonymized assessment response (e.g., response 62′ submitted by user 38), third anonymized assessment response (e.g., response 64′ submitted by user 40) and fourth anonymized assessment response (e.g., response 66′ submitted by user 42).

However, these anonymized assessment responses (e.g., response 62′, 64′, 66′) provided by assessment process 10 to user 36 would not include any information that discloses the identity of the participant who submitted the response. Accordingly, assessment process 10 may remove any and all information that identifies user 38 from response 62′; assessment process 10 may remove any and all information that identifies user 40 from response 64′; and assessment process 10 may remove any and all information that identifies user 42 from response 66′.

Accordingly and by anonymizing 108 (in whole or in part) the responses provided to a first participant (e.g., user 36) that were submitted by other participants (e.g., user 38, 40, 42), the first participant (e.g., user 36) may learn from the responses that were submitted by the other participants (e.g., user 38, 40, 42) while sparing the other participants (e.g., user 38, 40, 42) of any embarrassment that may occur if the responses submitted were of poor quality. As discussed above, these anonymized assessment responses may include (but is not limited to): a grade associated with the anonymized assessment response; an answer associated with the anonymized assessment response; and an explanation associated with the anonymized assessment response.

Accordingly, response 62′ may include a second grade (e.g., grade 70) assigned to user 38 by assessment process 10, a second answer provided by user 38 to assessment process 10, and a second explanation provided by user 38 to assessment process 10 (all in an anonymous fashion that does not identify user 38). Further, response 64′ may include a third grade (e.g., grade 72) assigned to user 40 by assessment process 10, a third answer provided by user 40 to assessment process 10, and a third explanation provided by user 40 to assessment process 10 (all in an anonymous fashion that does not identify user 40). Additionally, response 66′ may include a fourth grade (e.g., grade 74) assigned to user 42 by assessment process 10, a fourth answer provided by user 42 to assessment process 10, and a fourth explanation provided by user 42 to assessment process 10 (all in an anonymous fashion that does not identify user 42).

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or functional programming languages like Elixir. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
administering an electronic assessment to a first assessment participant and at least a second assessment participant;
assigning a first grade to the first assessment participant based, at least in part, upon a first assessment response received from the first assessment participant concerning the electronic assessment;
assigning at least a second grade to the at least a second assessment participant based, at least in part, upon at least a second assessment response received from the at least a second assessment participant concerning the electronic assessment;
anonymizing at least a portion of the at least a second assessment response, thus generating at least a second anonymized assessment response; and
providing the first grade and the at least a second anonymized assessment response to the first assessment participant.

2. The computer-implemented method of claim 1 wherein the at least a second anonymized assessment response includes at least a second grade associated with the at least a second response.

3. The computer-implemented method of claim 1 wherein the at least a second anonymized assessment response includes at least a second answer associated with the at least a second response.

4. The computer-implemented method of claim 1 wherein the at least a second anonymized assessment response includes at least a second explanation associated with the at least a second response.

5. The computer-implemented method of claim 1 wherein the at least a second assessment participant includes a plurality of assessment participants.

6. The computer-implemented method of claim 1 wherein the at least a second response includes a plurality of assessment responses.

7. The computer-implemented method of claim 1 further comprising:
processing a document to generate the electronic assessment.

8. A computer program product residing on a computer readable medium having a plurality of instructions stored thereon which, when executed by a processor, cause the processor to perform operations comprising:
administering an electronic assessment to a first assessment participant and at least a second assessment participant;
assigning a first grade to the first assessment participant based, at least in part, upon a first assessment response received from the first assessment participant concerning the electronic assessment;
assigning at least a second grade to the at least a second assessment participant based, at least in part, upon at least a second assessment response received from the at least a second assessment participant concerning the electronic assessment;
anonymizing at least a portion of the at least a second assessment response, thus generating at least a second anonymized assessment response; and
providing the first grade and the at least a second anonymized assessment response to the first assessment participant.

9. The computer program product of claim 8 wherein the at least a second anonymized assessment response includes at least a second grade associated with the at least a second response.

10. The computer program product of claim 8 wherein the at least a second anonymized assessment response includes at least a second answer associated with the at least a second response.

11. The computer program product of claim 8 wherein the at least a second anonymized assessment response includes at least a second explanation associated with the at least a second response.

12. The computer program product of claim 8 wherein the at least a second assessment participant includes a plurality of assessment participants.

13. The computer program product of claim 8 wherein the at least a second response includes a plurality of assessment responses.

14. The computer program product of claim 8 further comprising:
processing a document to generate the electronic assessment.

15. A computing system including a processor and memory configured to perform operations comprising:
administering an electronic assessment to a first assessment participant and at least a second assessment participant;
assigning a first grade to the first assessment participant based, at least in part, upon a first assessment response received from the first assessment participant concerning the electronic assessment;
assigning at least a second grade to the at least a second assessment participant based, at least in part, upon at least a second assessment response received from the at least a second assessment participant concerning the electronic assessment;
anonymizing at least a portion of the at least a second assessment response, thus generating at least a second anonymized assessment response; and
providing the first grade and the at least a second anonymized assessment response to the first assessment participant.

16. The computing system of claim 15 wherein the at least a second anonymized assessment response includes at least a second grade associated with the at least a second response.

17. The computing system of claim 15 wherein the at least a second anonymized assessment response includes at least a second answer associated with the at least a second response.

18. The computing system of claim 15 wherein the at least a second anonymized assessment response includes at least a second explanation associated with the at least a second response.

19. The computing system of claim 15 wherein the at least a second assessment participant includes a plurality of assessment participants.

20. The computing system of claim 15 wherein the at least a second response includes a plurality of assessment responses.

21. The computing system of claim 15 further comprising:
processing a document to generate the electronic assessment.

22. A computer-implemented method, executed on a computing device, comprising:
administering an electronic assessment to a first assessment participant and at least a second assessment participant;
assigning a first grade to the first assessment participant based, at least in part, upon a first assessment response received from the first assessment participant concerning the electronic assessment;
assigning at least a second grade to the at least a second assessment participant based, at least in part, upon at least a second assessment response received from the at least a second assessment participant concerning the electronic assessment; and
providing the first grade and the at least a second assessment response to the first assessment participant.

23. The computer-implemented method of claim 22 further comprising:
anonymizing at least a portion of the at least a second assessment response prior to providing the at least a second assessment response to the first assessment participant.

24. The computer-implemented method of claim 23 wherein the at least a second assessment response includes at least a second grade associated with the at least a second assessment response.

25. The computer-implemented method of claim 23 wherein the at least a second assessment response includes at least a second answer associated with the at least a second assessment response.

26. The computer-implemented method of claim 23 wherein the at least a second assessment response includes at least a second explanation associated with the at least a second assessment response.

27. The computer-implemented method of claim 22 wherein the at least a second assessment participant includes a plurality of assessment participants.

28. The computer-implemented method of claim 22 wherein the at least a second assessment response includes a plurality of assessment responses.

29. The computer-implemented method of claim 22 further comprising:
processing a document to generate the electronic assessment.
